(19) United States
(12) Patent Application Publication
(10) Pub. No.: US 2023/0273632 A1
(43) Pub. Date: Aug. 31, 2023

(54) PROPORTIONAL TO ABSOLUTE TEMPERATURE (PTAT) VOLTAGE GENERATING CIRCUIT FOR GENERATING A PTAT VOLTAGE AND ACTS AS A TEMPERATURE SENSOR

(71) Applicant: International Institute of Information Technology, Hyderabad, Hyderabad (IN)

(72) Inventors: Zia Abbas, Hyderabad (IN); Abhishek Pullela, Hyderabad (IN); Ashfakh Ali, Hyderabad (IN); Arpan Jain, Hyderabad (IN)

(21) Appl. No.: 18/115,649

(22) Filed: Feb. 28, 2023

(30) Foreign Application Priority Data
Feb. 28, 2022 (IN) 202241010862

(51) Int. Cl. G05F 1/56

(52) U.S. Cl. CPC G05F 1/56

(57) ABSTRACT

A proportional to-absolute-temperature (PTAT) voltage generating circuit connected between a power supply voltage source and a ground for providing a PTAT voltage at an output terminal of the PTAT voltage generating circuit to act as a temperature sensor is provided. The PTAT voltage generating circuit includes a plurality of PMOS transistors. The plurality of PMOS transistors generates a second PTAT voltage by multiplying a first PTAT voltage by a factor equal to a ratio of a first equivalent resistance (R2) and a second resistance (R1) of a first PMOS transistor (M4). The first equivalent resistance (R2) is obtained from a series combination of the plurality of PMOS transistors. The first PTAT voltage is generated by determining a difference between a base-emitter voltage of a first PNP transistor (T1) and the second PNP transistor (T2).

### CROSS-REFERENCE TO PRIOR-FILED PATENT APPLICATIONS

This application claims priority from the Indian provisional application no. 202241010862 filed on Feb. 28, 2022, which is herein incorporated by reference.

### TECHNICAL FIELD

The embodiments herein generally relate to a proportional to-absolute-temperature (PTAT) voltage-generating circuit, more particularly to the proportional to-absolute-temperature (PTAT) voltage-generating circuit for generating a PTAT voltage and acts as a temperature sensor.

### DESCRIPTION OF THE RELATED ART

Rapidly emerging IoT applications such as biomedical, smart homes, environmental monitoring, and surveillance require the employment of battery-operated low-power IoT systems. These systems are typically powered by miniaturized batteries or energy harvesters, which limit their total power consumption to tens of microwatts. Additionally, energy harvesters demand these systems to work for sub-IV supplies, while miniaturized batteries demand usability in a wide supply range precluding the need for a voltage regulator. Temperature sensors being an integral part of these systems, are desired to satisfy these demands.

Existing temperature sensors incorporate Bipolar Junction Transistors (BJTs) for generating a temperature-dependent voltage (usually a Proportional-To-Absolute-Temperature (PTAT) by taking the difference between the base-emitter voltages (ΔVBE) of two vertical PNP transistors. Although the obtained PTAT voltage is highly linear and process-invariant, the power consumption of the PTAT generator is of the order of µW, which makes them unsuitable for ultra-low power microsystems. Moreover, they do not work for lower supply voltages.

Conventional systems for the above problem use MOSFET-based temperature sensors in which the subthreshold region of operation has been exploited to generate PTAT voltages while consuming low power. Although the use of MOSFETs has facilitated the working of circuits at lower supplies, the temperature-dependent voltages show a significant deviation w.r.t process variations, demanding the need for one-point or two-point calibration techniques. Moreover, the power consumption of the PTAT generators is still high for the targeted applications that use architectures that generate process-independent PTAT voltages. However, the resistor-based architectures which consume nano amperes currents require impractical resistance of the order of Giga Ohms to scale down their current consumption to picoamperes, impractical resistances of the order of Gigaohms(GΩs) must be used.

Accordingly, there remains a need for a PTAT sensing element that occupies small area, without using resistors, or amplifiers, and with optimal output voltages.

### SUMMARY

In a view of the foregoing, an embodiment herein provides a proportional to-absolute-temperature (PTAT) voltage-generating circuit connected between a power supply voltage source and a ground for providing a PTAT voltage at an output terminal of the PTAT voltage-generating circuit to act as a temperature sensor. The PTAT voltage-generating circuit includes a first P-channel metal oxide semiconductor (PMOS) transistor (M4) comprises a gate terminal, a source terminal, and a drain terminal. The gate terminal of the first PMOS transistor (M4) is connected to a col lector of a second PNP transistor (T2). The second PNP transistor (T2) generates a first PTAT voltage by determining a difference between a base-emitter voltage of a first PNP transistor (T1) and the second PNP transistor (T2). An emitter of the first PNP transistor (T1) is connected to a first input terminal of a differential amplifier, and an emitter of the second PNP transistor (T2) is connected to a second input terminal of the differential amplifier. The first PTAT voltage is amplified by multiplying by a factor equal to a ratio of a first equivalent resistance (R2) and a second resistance (R1) of the first PMOS transistor (M4) to generate a second PTAT voltage. The first equivalent resistance (R2) is obtained from a series combination of a second PMOS transistor (M5), a third PMOS transistor (M6), a fourth PMOS transistor (M7), a fifth PMOS transistor (M8), a sixth PMOS transistor (M9), and a seventh PMOS transistor (M10). The second PTAT voltage is temperature invariant and act as the temperature sensor.

In some embodiments, the first PMOS transistor (M4), the second PMOS transistor (M5), the third PMOS transistor (M6), the fourth PMOS transistor (M7), the fifth PMOS transistor (M8), the sixth PMOS transistor (M9), and the seventh PMOS transistor (M10) generate a gate-leakage current that applies a square-law with respect to temperature, thereby enabling the PTAT voltage generating circuit to sense low temperatures down to -40° C.

In some embodiments, the PTAT voltage generating circuit is connected to a start-up circuit and a gate-leakage-based beta-multiplier circuit, wherein the start-up circuit and the gate-leakage-based beta-multiplier circuit are employed for a feedback loop, thereby to avoid degenerating bias points in the temperature sensor.

In some embodiments, tunneling currents of the first PMOS transistor (M4), the second PMOS transistor (M5), the third PMOS transistor (M6), the fourth PMOS transistor (M7), the fifth PMOS transistor (M8), the sixth PMOS transistor (M9), and the seventh PMOS transistor (M10) vary with a temperature that depends on gate-source voltage, wherein the tunneling currents range from Femto Amperes (fA) to pico Amperes (pA).

In some embodiments, the PTAT voltage generating circuit comprises an eighth PMOS transistor (M1), a ninth PMOS transistor (M2), and a tenth PMOS transistor (M3), each having a gate terminal, a source terminal, and a drain terminal, a gate terminal of the eighth PMOS transistor (M1), the ninth PMOS transistor (M2), and the tenth PMOS transistor (M3) are coupled to an output terminal of the differential amplifier, a source terminal of the eighth PMOS transistor (M1), the ninth PMOS transistor (M2), and the tenth PMOS transistor (M3) are coupled to a power supply voltage source, a drain terminal of the eighth PMOS transistor (M1) is connected to a first input terminal of the differential amplifier, a drain terminal of the ninth PMOS transistor (M2) is connected to a second input terminal of the differential amplifier, a drain terminal of the tenth PMOS transistor (M3) is coupled to an output terminal of the PTAT voltage generating circuit, the eighth PMOS transistor (M1), the ninth PMOS transistor (M2), and the tenth PMOS transistor (M3) mirrors the first PTAT voltage at the series combination.

In some embodiments, tunneling currents of the eighth PMOS transistor (M1), the ninth PMOS transistor (M2), and the tenth PMOS transistor (M3) vary with a temperature that depends on gate-source voltage, wherein the tunneling currents range from Femto Amperes (fA) to pico Amperes (pA).

In one aspect, a PTAT voltage generating circuit connected between a power supply voltage source and a ground for providing a PTAT voltage at an output terminal of the PTAT voltage generating circuit to act as a temperature sensor is provided. The PTAT voltage generating circuit includes a plurality of PMOS transistors, that generates a second PTAT voltage by multiplying a first PTAT voltage by a factor equal to a ratio of a first equivalent resistance (R2) that is obtained from a series combination of the plurality of PMOS transistors and a second resistance (R1) of a first PMOS transistor (M4), the first PTAT voltage is generated by determining a difference between a base-emitter voltage of a first PNP transistor (T1) and the second PNP transistor (T2).

In some embodiments, the plurality of PMOS transistors comprises the first PMOS transistor (M4), a second PMOS transistor (M5), and a third PMOS transistor (M6), a fourth PMOS transistor (M7), a fifth PMOS transistor (M8), a sixth PMOS transistor (M9), and a seventh PMOS transistor (M10), the series combination comprises the second PMOS transistor (M5), the third PMOS transistor (M6), the fourth PMOS transistor (M7), the fifth PMOS transistor (M8), the sixth PMOS transistor (M9), and the seventh PMOS transistor (M10).

In some embodiments, the plurality of PMOS transistors comprises an eighth PMOS transistor (M1), a ninth PMOS transistor (M2), and a tenth PMOS transistor (M3) that are connected to a differential amplifier mirrors the first PTAT voltage at the series combination.

In some embodiments, the plurality of PMOS transistors generates a gate-leakage current that applies a square-law with respect to temperature, thereby the PTAT voltage generating circuit senses low temperatures down to -40° C.

In some embodiments, the PTAT voltage generating circuit is connected with a start-up circuit and a gate-leakage-based beta-multiplier circuit, wherein the start-up circuit and the gate-leakage-based beta-multiplier circuit are used for a feedback loop avoiding degenerating bias points in the temperature sensor.

In some embodiments, tunneling currents of the plurality of PMOS transistors vary with a temperature that depends on gate-source voltage, the tunneling currents range from Femto Amperes (fA) to pico Amperes (pA).

In some embodiments, the one or more PMOS transistors are accumulation-mode gate-leakage transistors.

The PTAT temperature sensing element circuit generates a proportional to-absolute-temperature (PTAT) voltage. The PTAT temperature sensing element circuit acts as a temperature sensing element. The PTAT temperature sensing element circuit is process-invariant, thereby avoiding multiple calibrations and reducing cost. The PTAT temperature sensing element circuit consumes power in the order of pico-watts. The power does not increase exponentially with respect to temperature. The PTAT temperature sensing element circuit generates a gate-leakage current. The gate-leakage current applies a square-law with respect to temperature. Thereby, the PTAT temperature sensing element circuit is enabled to work at low temperatures down to 40° C. with low start-up times. The PTAT temperature sensing element circuit uses accumulation-mode gate-leakage transistors instead of large resistors, thereby drastically reducing the area. The PTAT temperature sensing element occupies an area of 0.005 mm2. It achieves a maximum non-linearity error of 0.12oC(3σ) over the temperature range of -55oC to 80oC. Without any trimming, a worst case inaccuracy of +0.36oC/ - 1.61oC is observed w.rt process variations, depicting the process-invariant nature of the temperature sensor. It also achieves a low supply sensitivity of 0.56oC/V over a wide supply range of 0.7 V-3 V. The power consumption of the sensor is 419pW at 27oC and 0.7 V supply.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a transistor-level implementation of a proportional to-absolute-temperature (PTAT) voltage-generating circuit for providing a PTAT voltage at an output terminal of the PTAT voltage-generating circuit to act as a temperature sensor according to some embodiments herein;

FIG. 2 illustrates a transistor-level implementation of a gate-leakage-based beta multiplier of the PTAT voltage-generating circuit according to some embodiments herein;

FIG. 3 illustrates a transistor-level implementation of a differential amplifier of a mirror circuit of the PTAT voltage-generating circuit according to some embodiments herein;

FIG. 4A is a graphical representation of a variation of a PTAT voltage of the PTAT voltage-generating circuit with respect to temperature according to some embodiments herein;

FIG. 4B is a graphical representation of a non-linearity error of the PTAT voltage-generating circuit with respect to temperature according to some embodiments herein;

FIG. 5A is a graphical representation of a ratio of a first equivalent resistance (R2) and a second equivalent resistance (R1) of the PTAT voltage-generating circuit with respect to temperature according to some embodiments herein;

FIG. 5B illustrates monte carlo simulations of a ratio of a first equivalent resistance (R2) and a second equivalent resistance (R1) of the PTAT voltage-generating circuit with respect to temperature according to some embodiments herein;

FIG. 6A is a graphical representation of a line sensitivity of the PTAT voltage-generating circuit with respect to temperature according to some embodiments herein; and

FIG. 6B is a graphical representation of a PTAT voltage of the PTAT voltage-generating circuit with respect to a start-up time according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

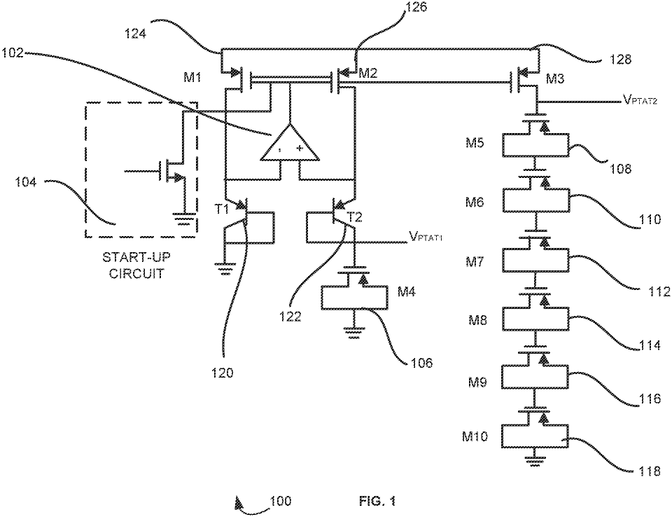

As mentioned, there remains a need for a PTAT voltage generating circuit to act as a temperature sensor whose power consumption is less than nano watts. Various embodiments disclosed herein provide PTAT sensing element circuit using one or more transistors that has power consumption less than nano watts and process invariant that consumes less area during fabrication process. Referring now to the drawings, and more particularly to FIGS. 1 through 6B, where similar reference characters denote corresponding features consistently throughout the figures, preferred embodiments are shown.

FIG. 1 illustrates a transistor-level implementation of a proportional to-absolute-temperature (PTAT) voltage-generating circuit 100 for providing a PTAT voltage at an output terminal of the PTAT voltage-generating circuit 100 to act as a temperature sensor according to some embodiments herein. The transistor-level implementation of the PTAT voltage generating circuit 100 includes one or more P-channel metal oxide semiconductor (PMOS) transistors, a mirror circuit, and one or more PNP transistors.

The one or more PMOS transistors includes a first PMOS transistor (M4) 106, a second PMOS transistor (M5) 108, a third PMOS transistor (M6) 110, a fourth PMOS transistor (M7) 112, a fifth PMOS transistor (M8) 114, a sixth PMOS transistor (M9) 116, and a seventh PMOS transistor (M10) 118. The one or more PMOS transistors may be thin oxide PMOS transistors. The mirror circuit includes a differential amplifier 102, and an eighth PMOS transistor (M1) 124, a ninth PMOS transistor (M2) 126, and a tenth PMOS transistor (M3) 128. The eighth PMOS transistor (M1) 124, the ninth PMOS transistor (M2) 126, and the tenth PMOS transistor (M3) 128 may be thick oxide transistors. The one or more PNP transistors includes a first PNP transistor (T1) 120 and a second PNP transistor (T2) 122. The differential amplifier 102 may be used to ensure the negative feedback in the loop. The differential amplifier 102 may be biased by a beta-multiplier circuit in which the physical resistance is replaced by a gate-leakage transistor to ensure sub-nano Watt power consumption.

The first PMOS transistor (M4) 106 includes a gate terminal, a source terminal, and a drain terminal. The gate terminal of the first PMOS transistor (M4) 106 is connected to a collector of the second PNP transistor (T2) 122. The second PNP transistor (T2) 122 generates a first PTAT voltage by determining a difference between a base-emitter voltage of a first PNP transistor (T1) 120 and the second PNP transistor (T2) 122. The following equation depicts the first PTAT voltage.

$${\text{V}}_{\text{PTATI}} = {\text{V}}_{\text{EBI}} - {\text{V}}_{\text{EB2}} , \qquad \text{→ equation 1}$$

where V_{EB1} is base-emitter voltage of the first PNP transistor 120, and V_{EB2} is base-emitter voltage of the second PNP transistor 122.

Considering the I-V relationship of the second PNP transistor 122, equation 1 may be re-written as:

$${\text{V}}_{\text{PTATI}} = V t ln ( \frac{l 01}{l s 1} ) - V t \text{ln(} \frac{l 02}{l s 2} ) - \qquad \text{→ equation 2}$$

The second PNP transistor T2 122 may consists of n1 parallel units, each identical to T1 and current in T1 is n2 times that in T2. This implies that I₀₁ = n₁I₀₂ and I_{S2} = n₂I_{S1}, which upon substitution in equation 2 leads to equation 3:

V_{PTAT1} = Vt In( n), where n = n1 ∗ n2. The slope of V _{PTAT1} is equal to (k/q) 1n(n) and to achieve higher slope values, n must be impractically large. For acceptable values of n (in this case, n is chosen to be 20), the PTAT voltage must be amplified in order to obtain higher slope values and thereby the PTAT voltage generating circuit 100 is higher sensitivity to temperature to act as a temperature sensor.

The first PTAT voltage is amplified by multiplying by a factor equal to a ratio of a first equivalent resistance (R2) and a second resistance (R1) of the first PMOS transistor (M4) to generate a second PTAT voltage. The first equivalent resistance (R2) is obtained from the series combination of the second PMOS transistor (M5) 108, the third PMOS transistor (M6) 110, the fourth PMOS transistor (M7) 112, the fifth PMOS transistor (M8) 114, the sixth PMOS transistor (M9) 116, and the seventh PMOS transistor (M10) 118.

The mirror circuit mirrors a current of the first PTAT voltage at a series combination of the second PMOS transistor (M5) 108, the third PMOS transistor (M6) 110, the fourth PMOS transistor (M7) 112, the fifth PMOS transistor (M8) 114, the sixth PMOS transistor (M9) 116, and the seventh PMOS transistor (M10) 118. The following equation depicts the second PTAT voltage.

$${\text{V}}_{\text{PTAT2}} = V P T A T 1 ( \frac{R 2}{R 1} )$$

The aspect ratio of the first PMOS transistor (M4) 106 may be set in order to achieve a desired bias current of 80pico Amperes in a ninth PMOS transistor (M2) 126, and a tenth PMOS transistor (M3) 128. The second PMOS transistor (M5) 108, the third PMOS transistor (M6) 110, the fourth PMOS transistor (M7) 112, the fifth PMOS transistor (M8) 114, the sixth PMOS transistor (M9) 116, and the seventh PMOS transistor (M10) 118 may be the replicated versions of the first PMOS transistor (M4) 106 with all of them having same aspect ratios as that of the first PMOS transistor (M4) 106. Since same current is made to flow through the first PMOS transistor (M4) 106 and the second PMOS transistor (M5) 108, the third PMOS transistor (M6) 110, the fourth PMOS transistor (M7) 112, the fifth PMOS transistor (M8) 114, the sixth PMOS transistor (M9) 116, and the seventh PMOS transistor (M10) 118, by symmetry arguments it may be determined that R2 = 6R1. Hence, V_{PTAT2} may be an upscaled version of V_{PTAT1} by a factor of 6.

In some embodiments, the first PMOS transistor (M4) 106, the second PMOS transistor (M5) 108, the third PMOS transistor (M6) 110, the fourth PMOS transistor (M7) 112, the fifth PMOS transistor (M8) 114, the sixth PMOS transistor (M9) 116, and the seventh PMOS transistor (M10) 118generate a gate-leakage current that applies a square-law with respect to temperature, thereby enabling the PTAT voltage generating circuit 100 to sense low temperatures down to -40° C.

The mirror circuit includes the eighth PMOS transistor (M1) 124, the ninth PMOS transistor (M2) 126, and the tenth PMOS transistor (M3) 128. A gate terminal of the eighth PMOS transistor (M1) 124, the ninth PMOS transistor (M2) 126, and the tenth PMOS transistor (M3) 128 are coupled to an output terminal of the differential amplifier 102. A source terminal of the eighth PMOS transistor (M1) 124, the ninth PMOS transistor (M2) 126, and the tenth PMOS transistor (M3) 128 are coupled to a power supply voltage source. A drain terminal of the eighth PMOS transistor (M1) 124 is connected to a first input terminal of the differential amplifier 102. A drain terminal of the ninth PMOS transistor (M2) 126 is connected to a second input terminal of the differential amplifier 102. A drain terminal of the tenth PMOS transistor (M3) 128 is coupled to an output terminal of the PTAT voltage generating circuit 100. The eighth PMOS transistor (M1) 124, the ninth PMOS transistor (M2) 126, and the tenth PMOS transistor (M3) 128 mirrors the first PTAT voltage at the series combination.

In some embodiments, tunneling currents of the eighth PMOS transistor (M1) 124, the ninth PMOS transistor (M2) 126, and the tenth PMOS transistor (M3) 128 vary with a temperature that depends on gate-source voltage, wherein the tunneling currents range from Femto Amperes (fA) to pico Amperes (pA).

In some embodiments, the first PMOS transistor (M4) 106, the second PMOS transistor (M5) 108, the third PMOS transistor (M6) 110, the fourth PMOS transistor (M7) 112, the fifth PMOS transistor (M8) 114, the sixth PMOS transistor (M9) 116, and the seventh PMOS transistor (M10) 118 generate a gate-leakage current that applies a square-law with respect to temperature, thereby enabling the PTAT voltage generating circuit to sense low temperatures down to -40° C.

In some embodiments, a start-up circuit 104 and the gate-leakage-based beta-multiplier circuit are connected to the PTAT voltage-generating circuit 100 that is used for a feedback loop to avoid degenerate bias points in the temperature sensor.

In some embodiments, tunneling currents of the first PMOS transistor (M4) 106, the second PMOS transistor (M5) 108, the third PMOS transistor (M6) 110, the fourth PMOS transistor (M7) 112, the fifth PMOS transistor (M8) 114, the sixth PMOS transistor (M9) 116, and the seventh PMOS transistor (M10) 118 vary with a temperature that depends on gate-source voltage. The tunneling currents range from Femto Amperes (fA) to pico Amperes (pA).

In some embodiments, the one or more PMOS transistors are accumulation-mode gate-leakage transistors.

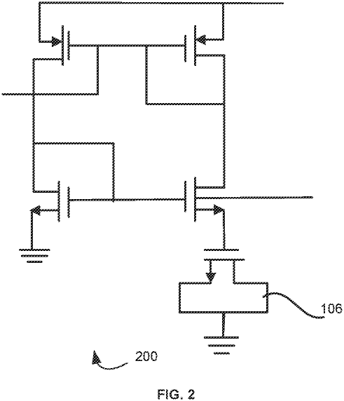

FIG. 2 illustrates a transistor-level implementation of a gate-leakage-based beta multiplier 200 of the PTAT voltage-generating circuit 100 according to some embodiments herein. The gate-leakage-based beta multiplier 200 of the PTAT voltage-generating circuit 100 biases the differential amplifier 102 of the mirror circuit. The physical resistance of the gate-leakage-based beta multiplier 200 is replaced by a gate-leakage transistor to ensure nano-watt power consumption.

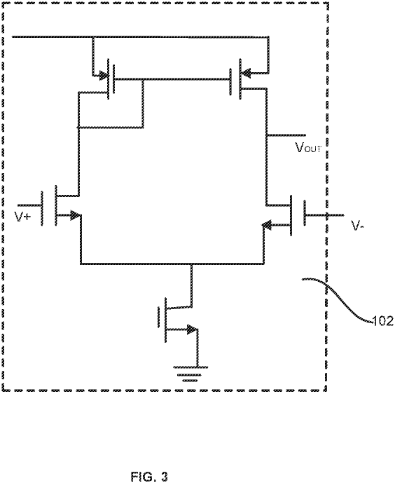

FIG. 3 illustrates a transistor-level implementation of a differential amplifier 102 of the PTAT voltage-generating circuit 100 according to an embodiment herein. The differential amplifier 102 is used through negative feedback in the loop with 52 decibels open loop gain. The first PTAT voltage is generated at the gate of the transistor M4. The differential amplifier 102 may be used to obtain higher slope values with higher sensitivity to temperatures.

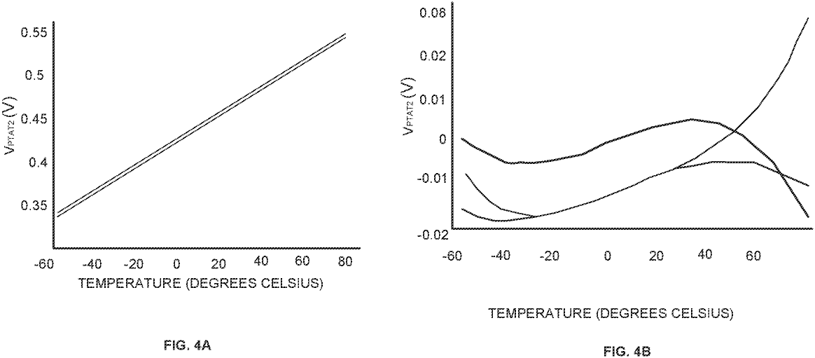

FIG. 4A is a graphical representation of a variation of a PTAT voltage of the PTAT voltage-generating circuit 100 with respect to temperature according to some embodiments herein. The graphical representation depicts a variation of a PTAT voltage of the PTAT voltage-generating circuit 100 on Y axis and the temperature on X axis.

FIG. 4B is a graphical representation of a non-linearity error of the PTAT voltage-generating circuit 100 with respect to temperature according to some embodiments herein. The graphical representation depicts a non-linearity error of the PTAT voltage-generating circuit 100 on Y axis and the temperature on X axis. The maximum non-linearity error is observed to be 0.025% (translates to 0.12oC) which indicates that the temperature sensor is highly linear. Without any calibration, the deviations in the worst case corners from the typical value are +0.1%/-0.5% (+0.36° C./ - 1.61° C.).

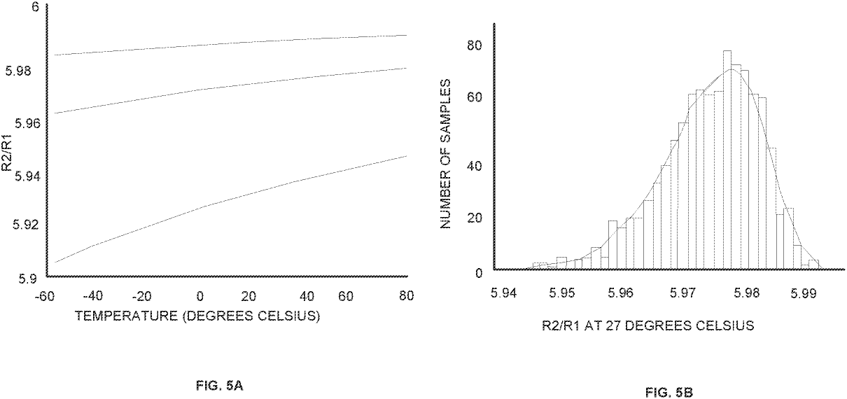

FIG. 5A is a graphical representation of a ratio of a first equivalent resistance (R2) and a second equivalent resistance (R1) of the PTAT voltage-generating circuit 100 with respect to temperature according to some embodiments herein. The graphical representation depicts the ratio of a first equivalent resistance (R2) and a second equivalent resistance (R1) of the PTAT voltage-generating circuit on Y axis and temperature on the X axis.

FIG. 5B illustrates monte carlo simulations of a ratio of a first equivalent resistance (R2) and a second equivalent resistance (R1) of the PTAT voltage-generating circuit 100 with respect to temperature according to some embodiments herein. The monte carlo simulations depicts number of samples on Y axis and the ratio of a first equivalent resistance (R2) and a second equivalent resistance (R1) on the X axis at 27° C. The maximum error in R2/R1 due to temperature variation is 0.59%. The process and mismatch variations are negligible, for example, (±3 σ) is 0.8%. Hence the ratio R2/R1 is temperature and process invariant.

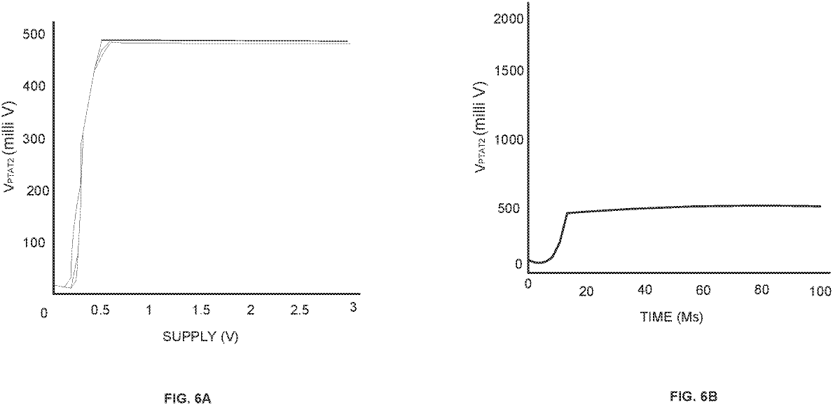

FIG. 6A is a graphical representation of a line sensitivity of the PTAT voltage-generating circuit 100 with respect to temperature according to some embodiments herein. The graphical representation depicts a line sensitivity of the PTAT voltage-generating circuit 100 on Y axis and temperature on X axis. The line sensitivity of 0.56oC/V is obtained in a wide supply range of 0.7 Volts-3 Volts.

FIG. 6B is a graphical representation of a PTAT voltage of the PTAT voltage-generating circuit with respect to a start-up time according to some embodiments herein. The graphical representation depicts the PTAT voltage of the PTAT voltage-generating circuit on Y axis and the start-up time on X axis. The start-up time is 15 milli seconds, considering that the start-up time has reached 95% of the steady state value. The start-up time is quite high comparable to pico-watt self-biased voltage-generating circuits.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A proportional to-absolute-temperature (PTAT) voltage generating circuit connected between a power supply voltage source and a ground for providing a PTAT voltage at an output terminal of the PTAT voltage generating circuit to act as a temperature sensor, comprising:
a first P-channel metal oxide semiconductor (PMOS) transistor (M4) that comprises a gate terminal, a source terminal, and a drain terminal, wherein the gate terminal of the first PMOS transistor (M4) is connected to a collector of a second PNP transistor (T2),
wherein the second PNP transistor (T2) generates a first PTAT voltage by determining a difference between a base-emitter voltage of a first PNP transistor (T1) and the second PNP transistor (T2), wherein an emitter of the first PNP transistor (T1) is connected to a first input terminal of a differential amplifier, and an emitter of the second PNP transistor (T2) is connected to a second input terminal of the differential amplifier,
wherein the first PTAT voltage is amplified by multiplying by a factor that is equal to a ratio of a first equivalent resistance (R2) and a second resistance (R1) of the first PMOS transistor (M4) to generate a second PTAT voltage,
wherein the first equivalent resistance (R2) is obtained from a series combination of a second PMOS transistor (M5), a third PMOS transistor (M6), a fourth PMOS transistor (M7), a fifth PMOS transistor (M8), a sixth PMOS transistor (M9), and a seventh PMOS transistor (M10), wherein the second PTAT voltage is temperature invariant and thereby, the PTAT voltage generating circuit act as the temperature sensor.

2. The PTAT voltage generating circuit of claim 1, wherein the first PMOS transistor (M4), the second PMOS transistor (M5), the third PMOS transistor (M6), the fourth PMOS transistor (M7), the fifth PMOS transistor (M8), the sixth PMOS transistor (M9), and the seventh PMOS transistor (M10) generate a gate-leakage current that applies a square-law with respect to temperature, thereby enabling the PTAT voltage generating circuit to sense low temperatures down to -40° C.

3. The PTAT voltage generating circuit of claim 1, wherein the PTAT voltage generating circuit is connected to a start-up circuit and a gate-leakage-based beta-multiplier circuit, wherein the start-up circuit and the gate-leakage-based beta-multiplier circuit are employed for a feedback loop, thereby avoiding degenerating bias points in the temperature sensor.

4. The PTAT voltage generating circuit of claim 1, wherein tunneling current of the first PMOS transistor (M4), the second PMOS transistor (M5), the third PMOS transistor (M6), the fourth PMOS transistor (M7), the fifth PMOS transistor (M8), the sixth PMOS transistor (M9), and the seventh PMOS transistor (M10) vary with a temperature that depends on gate-source voltage, wherein the tunneling current range from Femto Amperes (fA) to pico Amperes (pA).

5. The PTAT voltage generating circuit of claim 1, wherein the PTAT voltage generating circuit comprises an eighth PMOS transistor (M1), a ninth PMOS transistor (M2), and a tenth PMOS transistor (M3), each having a gate terminal, a source terminal, and a drain terminal wherein a gate terminal of the eighth PMOS transistor (M1), the ninth PMOS transistor (M2), and the tenth PMOS transistor (M3) are coupled to an output terminal of the differential amplifier, wherein a source terminal of the eighth PMOS transistor (M1), the ninth PMOS transistor (M2), and the tenth PMOS transistor (M3) are coupled to a power supply voltage source, wherein a drain terminal of the eighth PMOS transistor (M1) is connected to a first input terminal of the differential amplifier, wherein a drain terminal of the ninth PMOS transistor (M2) is connected to a second input terminal of the differential amplifier, wherein a drain terminal of the tenth PMOS transistor (M3) is coupled to an output terminal of the PTAT voltage generating circuit, wherein the eighth PMOS transistor (M1), the ninth PMOS transistor (M2), and the tenth PMOS transistor (M3) mirrors the first PTAT voltage at the series combination.

6. The PTAT voltage generating circuit of claim 5, wherein tunneling currents of the eighth PMOS transistor (M1), the ninth PMOS transistor (M2), and the tenth PMOS transistor (M3) vary with a temperature that depends on gate-source voltage, wherein the tunneling currents range from Femto Amperes (fA) to pico Amperes (pA).

7. A PTAT voltage generating circuit connected between a power supply voltage source and a ground for providing a PTAT voltage at an output terminal of the PTAT voltage generating circuit to act as a temperature sensor, comprising:
a plurality of PMOS transistors, that generates a second PTAT voltage by multiplying a first PTAT voltage by a factor equal to a ratio of a first equivalent resistance (R2) that is obtained from a series combination of the plurality of PMOS transistors and a second resistance (R1) of a first PMOS transistor (M4), wherein the first PTAT voltage is generated by determining a difference between a base-emitter voltage of a first PNP transistor (T1) and the second PNP transistor (T2).

8. The PTAT voltage generating circuit of claim 7, wherein the plurality of PMOS transistors comprise the first PMOS transistor (M4), a second PMOS transistor (M5), and a third PMOS transistor (M6), a fourth PMOS transistor (M7), a fifth PMOS transistor (M8), a sixth PMOS transistor (M9), and a seventh PMOS transistor (M10), wherein the series combination comprises the second PMOS transistor (M5), the third PMOS transistor (M6), the fourth PMOS transistor (M7), the fifth PMOS transistor (M8), the sixth PMOS transistor (M9), and the seventh PMOS transistor (M10).

9. The PTAT voltage generating circuit of claim 7, wherein the plurality of PMOS transistors comprise an eighth PMOS transistor (M1), a ninth PMOS transistor (M2), and a tenth PMOS transistor (M3) that are connected to a differential amplifier mirrors the first PTAT voltage at the series combination.

10. The PTAT voltage generating circuit of claim 7, wherein the plurality of PMOS transistors generate a gate-leakage current that applies a square-law with respect to temperature, thereby the PTAT voltage generating circuit senses low temperatures down to -40° C.

11. The PTAT voltage generating circuit of claim 7, wherein the PTAT voltage generating circuit is connected with a start-up circuit and a gate-leakage-based beta-multiplier circuit, wherein the start-up circuit and the gate-leakage-based beta-multiplier circuit are used for a feedback loop to avoid degenerating bias points in the temperature sensor.

12. The PTAT voltage generating circuit of claim 6, wherein tunneling currents of the plurality of PMOS transistors vary with a temperature that depends on gate-source voltage, wherein the tunnelling currents ranges from femto Amperes (fA) to pico Amperes (pA).

13. The PTAT voltage generating circuit of claim 6, wherein the plurality of PMOS transistors are accumulation-mode gate-leakage transistors.
